(19) United States
(12) Patent Application Publication
(10) Pub. No.: US 2007/0193012 A1
(43) Pub. Date: Aug. 23, 2007

(54) Metal forming process

(76) Inventors: Robert Bergman, Lawrenceville, GA (US); Charles E. Moore, Kennesaw, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/362,272

(22) Filed: Feb. 22, 2006

(51) Int. Cl. B21D 31/00; B23Q 17/00

(52) U.S. Cl. 29/407.01; 29/407.04; 72/379.2

(57) ABSTRACT

The present invention generally relates to improved process control systems and methods for sheet metal forming processes. Embodiments of the present invention utilize machine vision systems to monitor features of a product created by a sheet metal forming process and alter process parameters based at least in part on the failure of a monitored feature to satisfy a predetermined standard.

### FIELD OF THE INVENTION

The present invention relates to systems and methods for processing metal. More particularly, embodiments of the present invention utilize machine vision systems to control parameters of a stamping or metal forming operation.

### BACKGROUND OF THE INVENTION

A major challenge facing sheet metal fabricators is how to meet increasing demands for tighter tolerances while at the same time maintaining a competitive price. One known method for controlling a manufacturing process is to use statistical sampling techniques to detect and/or predict when a process will produce a component out of tolerance. Typically, the sampled parts must fall within a reduced tolerance band for the process to continue running. If a sampled part falls outside the reduced tolerance band, the process is stopped so an adjustment can be made. With tighter tolerance demands, often the manufacturing process cannot consistently produce parts within the narrowed tolerance band, resulting in significant downtime for adjustments to the process.

Although statistical sampling may be useful when the monitored dimensions gradually drift out of specification, this technique often misses sudden changes in a process or intermittent defects. When the defect is eventually detected, costly manual inspection is typically required to sort out the defective components.

In addition to demands for tighter tolerances in traditional metal forming applications, new technologies have led to new applications for formed metal products. This is especially true for expanded metal. Traditionally, the mesh created by an expanded metal process has been used for machine guards, security fencing, and grating for stairs and catwalks. Small aperture or micromesh expanded metal has also been utilized in filters and air bags. These applications push the limits on conventional expanded metal processes due to the tight tolerances and the small aperture sizes required. Furthermore, because an air bag is a safety critical component of an automobile, quality requirements are heightened.

Present methods for monitoring expanded metal mesh include manually inspecting the aperture size using a “go” gage pin with a diameter sized to fit tightly within the smallest allowable aperture and a “no-go” gage pin with a diameter sized slightly larger than the largest allowable aperture such that it will not penetrate the largest allowable aperture. To determine the acceptability of an expanded metal mesh, an inspector will check a percentage of the apertures in a given length of mesh. An aperture is acceptable if the go pin can penetrate the aperture and the no-go pin cannot. While this technique may have been useful with relatively large apertures, it is difficult to perform these types of checks on micromesh expanded metal due in part to the quantity of apertures in micromesh, which is substantially greater. It can be time consuming to check the same percentage of apertures in the same given length of micromesh as opposed to standard expanded metal mesh. Moreover, the small size of the apertures increases the difficulty of inserting the go pin into an aperture, which may result in mistaken rejections.

Accordingly, a need exists for improved process control systems and methods that facilitate tighter tolerances without significantly reducing productivity and that address deficiencies in the known art, some of which are described above.

### BRIEF SUMMARY OF THE INVENTION

To address deficiencies in the current state of the art, some of which are discussed above, the present invention provides improved process control systems and methods for sheet metal forming. Embodiments of the present invention utilize machine vision systems to monitor features of a product created by a sheet metal forming process and alter process parameters based at least in part on the failure of a monitored feature to satisfy a predetermined standard.

In one embodiment, a process control system for a sheet metal forming process having one or more adjustable processing parameters is provided. The system includes a press having an upper knife and a lower knife. The press is configured to receive a predetermined length of sheet metal between the upper knife and the lower knife and to create a product by sequentially moving the upper knife from a first position spaced apart from the lower knife to a second position proximate the lower knife wherein the upper and lower knives are in contact with the predetermined length of sheet metal. The sequential movement creates a product. The system also includes a machine vision system configured to capture an image of at least a portion of the product, and to generate dimensional data by determining a dimension of at least one feature of the product by analyzing the image; and a process controller configured to receive the dimensional data from the machine vision system, the process controller further configured to alter one or more of the processing parameters in response to the dimensional data failing to satisfy a predetermined threshold.

In another embodiment, a method of controlling a sheet metal forming operation is provided. The method includes the steps of: indexing a predetermined length of sheet metal between a first knife and a second knife; sequentially moving the upper knife from a first position spaced apart from the lower knife to second position proximate the lower knife wherein the upper knife and the lower knife are in contact with opposing surfaces of the indexed sheet metal at the second position thereby creating a product; capturing an image of at least a portion of the product; processing the image to determine a dimension of one feature of the product to create dimensional data; comparing the dimensional data to a given threshold; and adjusting a processing parameter in response to the first measurement data exceeding the threshold.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic view of a process control system in accordance with an embodiment of the present invention.

FIG. 2 is a schematic diagram of a portion of an expanded metal press in accordance with an embodiment of the present invention.

FIG. 3 is a schematic diagram of a machine vision system in accordance with an embodiment of the present invention.

FIGS. 4A-E are schematic diagrams illustrating process steps for creating expanded metal in accordance with an embodiment of the present invention.

FIG. 5 is a flow diagram illustrating the steps of a process control method in accordance with an embodiment of the present invention.

FIG. 6 is a schematic diagram illustrating a portion of an expanded metal mesh in accordance with an embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

General Operation and Structure

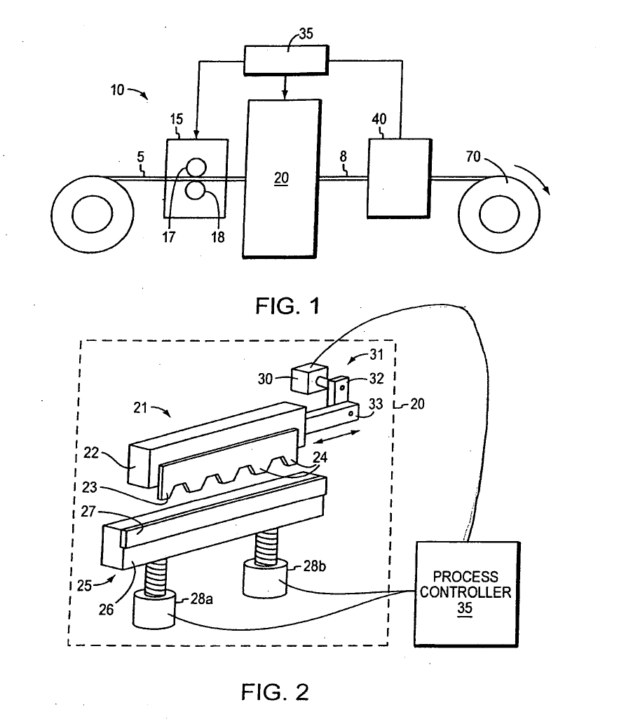

In FIG. 1, an embodiment of the present invention is illustrated that provides improved process control for sheet metal forming processes using feedback from a machine vision system to adjust processing parameters. As shown, this embodiment includes a raw material feeding mechanism 15, a press 20, a process controller 35, a machine vision system 40 and a tension mechanism 70. Generally described the machine vision system 40 captures an image of at least a portion of the processed sheet metal 8 and evaluates specific characteristics thereof. This analysis is communicated to the process controller 35 which may alter processing parameters in the event monitored characteristics fall outside of predetermined limits.

For ease of understanding, embodiments of the present invention will now be described with reference to an expanded metal process. However, as one of ordinary skill in the art will appreciate, embodiments of the present invention may be used in connection with any metal forming process such as, without limitation, bending, forming, stamping and drawing.

Expanded metal is created by shearing and expanding sheet metal. The sheet metal 5 is typically received in a coil, progressively unwound from the coil and fed into a press 20. Under some circumstances, the sheet metal 5 may be provided in individual strips, which are fed into the press 20. Cold rolled steel is often the raw material used for expanded metal; however, any suitable sheet metal may be used in connection with the present invention such as steel, copper, aluminum or any alloy thereof.

In the illustrated embodiment, the feeding mechanism 15 indexes a predetermined length of the sheet metal 5 into the press 20. To accomplish this task, the feeding mechanism 15 utilizes two parallel rollers 17, 18, which are spaced apart and configured to receive the sheet metal 5 therebetween. One or both of the rollers may be rotated by a servo motor (not shown) in order to index a predetermined length of sheet metal 5 into the press 20. As one of skill in the art will appreciate, any suitable motor may be used to rotate the feeding mechanism rollers.

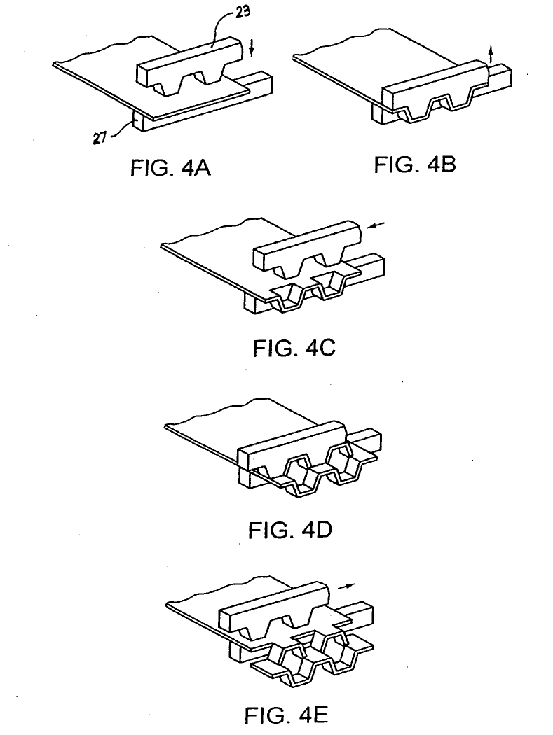

FIG. 2 illustrates a portion of press 20 that may be used to create expanded metal in accordance with an embodiment of the present invention. Press 20 includes an upper knife assembly 21, a lower knife assembly 25, two adjustment actuators 28a, 28b, a servo motor 30 and a linkage mechanism 31. The upper knife assembly 21 is configured to descend to a position proximate the lower knife assembly 25 thereby shearing and expanding a portion of the sheet metal indexed into the press 20. The upper knife assembly 21 then rises, shifts laterally under control of the servo motor 30 and descends again after another predetermined length of sheet metal has been indexed into the press by the feeding mechanism 15 (FIG. 1). As a result, a mesh comprising a plurality of apertures configured in staggered rows is created. This process will be discussed in greater detail with reference to FIGS. 4A-4E.

The upper knife assembly 21 includes a knife holder 22 and an upper knife 23 securely attached thereto with the cutting edge of the upper knife 23 extending from the knife holder 22. In the illustrated embodiment, the cutting edge of the upper knife 23 includes a plurality of teeth 24. While the teeth 24 in FIG. 2 are shown with a truncated triangular shape, it will be appreciated by those of skill in the art that the upper knife 23 may have any tooth pattern as desired such as a non-truncated triangle or semicircle shape.

In one embodiment, the press's rising and descending strokes are actuated by a cam and suitable motor (not shown) that are operatively connected to the upper knife assembly 21; however, as will be appreciated by one of skill in the art, other types of presses may be used in connection with the present invention such as a punch press, press brake or hydraulic press.

In addition to opening and closing relative to the lower knife assembly 25, the upper knife assembly 21 is also configured to move in a direction substantially parallel with the longitudinal axis of the upper knife 23 between a first location and a second location. Generally, the distance between the first and second location is substantially the same as half the distance between two teeth 24 on the upper knife 23. In the illustrated embodiment, this movement is actuated by servo motor 30 and linkage 31. Linkage 31 is configured to convert the rotational movement of the servo motor 30 into a linear motion thereby moving the upper knife assembly 21 in a direction substantially parallel to its longitudinal axis. In the illustrated embodiment, the linkage 31 includes rotational member 32 which is rigidly connected to the servo motor 30 output shaft and an axial member 33 pivotably connected proximate one end to rotational member 32 and operatively connected to the upper knife assembly 21 at the opposite end. It should be understood by those of skill in the art that the axial movement of the upper knife assembly 21 may be accomplished using any known or developed mechanism such as a cam or other linear actuators.

The lower knife assembly 25 includes a knife holder 26 and a lower knife 27 securely fastened thereto. The lower knife 27 has a straight cutting edge substantially parallel with its longitudinal axis which is oriented substantially parallel with the longitudinal axis of the upper knife 23. In operation, the lower knife 27 cooperates with the upper knife 23 to shear the sheet metal when the upper knife assembly 21 is positioned proximate the lower knife assembly 25.

The lower knife actuators 28a, 28b determine the height of the lower knife assembly 25 in relation to the upper knife assembly 21 in an axis substantially perpendicular to the cutting edge of the lower knife 27 as shown in FIG. 2. In the illustrated embodiment, two actuators 28a, 28b are operatively attached to the lower knife assembly 25; however, it should be understood that any number of actuators may be used in connection with the present invention. In one embodiment, the actuators 28a, 28b each include a servo motor and a mechanism that translates the rotational movement of the motor to a linear motion in order to adjust the lower knife assembly location.

Referring to FIGS. 1 and 2, the operation of the feeding mechanism 15 and the press 20 are controlled by the process controller 35. More particularly, the process controller 35 is configured to send command signals to the feeding mechanism servo (not shown), the upper knife servo 30 and the lower knife actuators 28a, 28b indicating when and to what degree to actuate. In addition, the process controller 35 is configured to receive measurement data from the machine vision system 40 and to compare the measurement data received to predetermined standards. If the standards are not met, the process controller may alter appropriate manufacturing parameters in response. For example, the process controller may alter the amount of sheet metal indexed by the feeding mechanism 15 or change the location of the lower knife assembly by sending appropriate command signals to the actuators 28a or 28b. Furthermore, those of skill in the art will appreciate that the process controller 35 may be configured to receive signals from other sensors to synchronize the actuation of the various servos. For example, one or more proximity switches (not shown) may be mounted on the press 20 to sense when the upper knife assembly 21 is spaced apart from or proximate to the lower knife assembly 25.

In one embodiment, the process controller 35 is a programmable logic controller (“PLC”); however, as one of ordinary skill in the art will appreciate, any data processing device may be used in connection with the present invention such as, without limitation, a personal computer or a customized micro-controller.

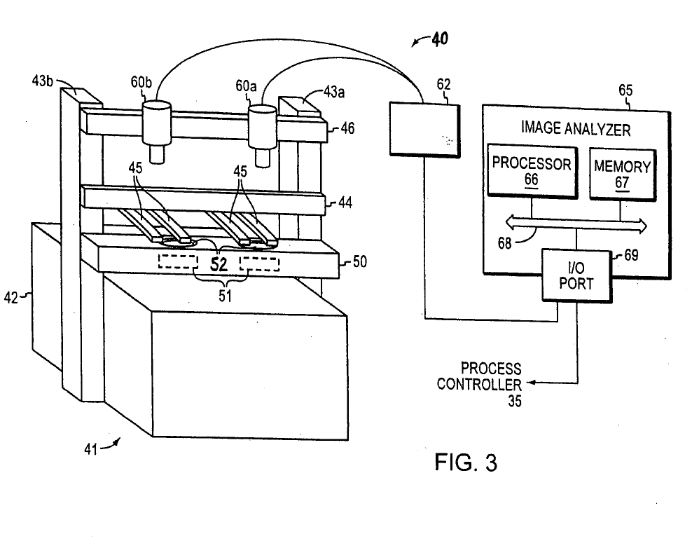

After the expanded metal mesh is created in the press 20, it is fed into the machine vision system 40 for inspection. FIG. 3 illustrates a machine vision system 40 in accordance with an embodiment of the present invention. In the illustrated embodiment, the machine vision system 40 includes an alignment fixture 41, an illumination tube 50, two cameras 60a, 60b, a camera interface 62 and an image analyzer 65.

The alignment fixture 41 is configured to receive the expanded metal from the press 20 and present at least a portion of the expanded metal to one or more cameras to facilitate image capture. In the illustrated embodiment, the alignment fixture 41 includes a base 42, two substantially parallel support columns 43a, 43b, a cross member 44, four support fingers 45 and a camera support bar 46.

The base 42 has a generally rectangular shape and is configured to be placed on a substantially planar support surface. Securely attached to opposing sides of the base 42 are the two support columns 43a, 43b, which extend above the upper surface of the base 42 as shown in FIG. 3. In an alternative embodiment, the support columns 43a, 43b are attached to the same side of the base 42 and spaced apart in order to receive the expanded metal therebetween. The support columns 43a, 43b may be used to guide the expanded metal through the alignment fixture 41 as desired.

The cross member 44 is adjustably attached to both support columns 43a, 43b at a location above the base 42. Securely attached to the cross member 44 are four support fingers 45 which help guide the expanded metal through the alignment fixture 41. In the illustrated embodiment, two parallel fingers 45 are utilized for each of the cameras 60a, 60b with the support fingers 45 spaced apart to allow the associated camera to capture an image of the expanded metal therebetween. It should be understood, however, that any number of support fingers may be attached to the cross member 44 as desired.

Furthermore, the cross member 44 may be adjusted such that the support fingers urge the expanded metal against the illumination tube 50. This may be desired to reduce vibration as the expanded metal strip passes beneath the cameras and also to hold the expanded metal at a constant vertical position relative to the cameras. The support fingers 45 may be rigid or flexible as desired.

In an alternative embodiment, a cross member 44 and support figures are not utilized.

The camera support bar 46 is adjustably attached to the support columns 43a, 43b such that the cross member 44 is intermediate the camera support bar 46 and the base 42. The camera support bar 46 may be adjusted along at least a portion of the length of the support columns in order to optimize the image captured by the cameras 60a, 60b.

The illumination tube 50 provides back lighting for at least a portion of the expanded metal to facilitate image capture by the cameras 60a, 60b. This tube is positioned adjacent the support columns 43a, 43b and atop the base 42. In the illustrated embodiment, the tube has a generally rectangular cross section and includes two illumination sources 51 positioned therein; however it should be understood that the tube may have other cross sections such as triangular or round. The illumination source may be, without limitation, an incandescent bulb, fluorescent bulb, light emitting diode, laser or any other illuminating device known or developed and any number of illuminating devices may be used.

The illumination tube 50 in the illustrated embodiment is constructed of non-transparent material and includes two suitably sized apertures 52 located in alignment with the cameras 60a, 60b. In use, the expanded metal mesh is fed between the illumination tube 50 and the support fingers 45 with the cameras positioned to capture images of a portion of the expanded metal between the support fingers. The apertures 52 direct light from the illumination sources to the portion of the expanded metal to be imaged. Alternatively, a single aperture may be utilized to provide illumination for both cameras.

In an alternative embodiment, the illumination tube 50 is constructed of transparent material and therefore apertures are not necessary to allow light from the illumination sources 51 to light the expanded metal. In yet another embodiment, an illumination tube is not utilized and the expanded metal is illuminated from the imaged side of the expanded metal using ambient light, strobe light or other known or developed lighting technique.

The cameras 60a, 60b are secured to the camera support bar 44 using suitable bracketry. The cameras 60a, 60b are spaced apart such that each camera captures a different portion of the expanded mesh. In one embodiment, the portions captured are proximate the two edges of the expanded mesh. While FIG. 3 illustrates two cameras, a person of skill in the art will appreciate that any number of cameras may be used in connection with the present invention.

In one embodiment of the present invention, digital cameras capable of capturing black and white images with a suitable lens are utilized. The digital cameras may employ charge-coupled devices (CCD), a complementary metal-oxide-semiconductor (CMOS) or other known or developed image sensors to capture the image. In further embodiments, color and/or analog cameras may be used as desired.

In one embodiment of the present invention, the cameras 60a, 60b are configured to receive triggering signals that indicate a new portion of the expanded metal mesh has been indexed under the cameras. This signal may be sent from process controller 35 to indicate the feeding mechanism 15 has indexed additional material into the press 20 which coincides with a new portion of the expanded metal being indexed under the cameras 60a, 60b. Alternatively, a sensor (not shown) may be included in the alignment fixture 41 to sense movement of the expanded metal mesh and to send a triggering signal to the camera. In a further embodiment, the cameras may trigger themselves using an internal timer (not shown). For example, the camera may take images every second. As will be understood by those of skill in the art, any type of triggering mechanism may be used in connection with the present invention.

The images captured by the cameras 60a, 60b are communicated to a camera interface 62 which facilitates transfer of the image to the image analyzer 65. The image transferred may comprise analog or digital image data. The camera interface may or may not process image data received from the camera prior to transferring it to the image analyzer 65. For example, in one embodiment, the camera interface 62 transfers the image data directly from the camera into the image analyzer using a known or developed transfer protocol such as IEEE 1394. In an alternative embodiment, the camera interface digitizes or otherwise processes the image data received from the camera before transferring to the image analyzer 65.

The image analyzer 65 is configured to process the image data received from the camera interface 62 and may be a personal computer, microprocessor or other data processing device. The image analyzer 65 includes a processor 66, a memory 67, a communication bus 68 and input/output ports 69. The processor executes software instructions, which are stored in the memory 67, to carry out defined steps. The memory 67 may include various combinations of volatile, non-volatile and mass storage type devices. Volatile memory may include RAM or other forms which retain the contents only during operation. Non-volatile memory may include ROM, EPROM, EEPROM, FLASH, or other types of memory that retain the memory contents at all times. Examples of mass storage devices include floppy disk, hard disk, compact disk, and DVD. The memory 67 receives image data from the camera interface via the input/output ports. The processor 66, memory 67 and input/output ports 69 communicate via the communications bus 68.

The input/output ports are configured to receive data from the camera interface 62 and to send image analysis data to the process controller 35. To facilitate these communications, the input/output ports may include standard communication ports such as RS-232, RS-422, DIN, USB, IEEE 1394 or any other communication port known or developed. The input/output ports may also communicate wirelessly with other devices using IEEE 802.11, 802.15 or other wireless communication protocols. In addition to providing communication links to the camera interface 62 and process controller 35, the input/output ports may also provide links to other peripheral devices such as local printers, a monitor, a keyboard, and a mouse or other typical pointing devices (e.g., rollerball, trackpad, joystick, etc.).

Returning to FIG. 1, a tensioning device 70 is provided downstream of the machine vision system 40 in the illustrated embodiment. The tensioning device 70 receives the expanded metal mesh from the machine vision system 40 and rolls it into a coil. In addition, the tensioning device 70 also maintains tension in the produced expanded metal mesh such that the produced expanded metal mesh indexes through the alignment fixture 41 of the machine vision system 40 as sheet metal is indexed into the press 20.

As will be understood by those skilled in the art, any indexing mechanism known or developed may be used with the present invention to feed the expanded metal through the machine vision system 40. For example, a feeding mechanism similar to that described above for indexing raw material into the press 20 may be placed between the press 20 and the machine vision system 40 or after the machine vision system 40 to index the expanded metal into the machine vision system 40.

Method for Creating Expanded Metal

To better understand the control features present in embodiments of the present invention, a description of the expanded metal process is provided with reference to FIGS. 1, 2 and 4A-E. Generally described, the process for creating expanded metal requires shearing and expanding sheet metal to form a plurality of apertures. The process begins with a predetermined length of sheet metal indexed between the upper knife 23 and the lower knife 27 as shown in FIG. 4a. The feed timing and predetermined length of sheet metal is controlled by the process controller 35 which sends command signals to the feeder servo indicating the rotation angle for the servo.

Turning to FIG. 4B, the upper knife 23 descends towards the lower knife 27 such that its teeth shear the sheet metal in cooperation with the lower knife 27 and also stretch or expand the metal creating a plurality of apertures. The apertures resulting from this stroke of the press represent half of the final expanded metal aperture shape.

Next, the upper knife 23 rises from the lower knife 27 allowing an additional predetermined length of sheet metal to be advanced by the feeding mechanism under control of the process controller 35 as generally shown in FIG. 4C. The length of the sheet metal feed may be approximately equal to the thickness of the upper knife.

Meanwhile, the upper knife 23 is shifted in a direction substantially parallel with the cutting edge of the upper knife 23 from a first position to a second position. The timing and distance traveled by the upper knife is controlled by the process controller 35, which sends signals to the upper knife servo 30 indicating the rotation angle for the servo. The distance traveled between the first and second positions may be approximately equal to one half tooth of the upper knife 23.

Referring to FIG. 4D, the upper knife 23 descends against the sheet metal towards the lower knife 27 shearing the metal and completing the apertures of the prior press stroke. Next, the upper knife is raised again, shifted axially back to the first position under control of the process controller 35. The resulting mesh structure comprises a plurality of staggered apertures in the metal sheet as can be seen in FIG. 4E.

Method for Controlling an Expanded Metal Process

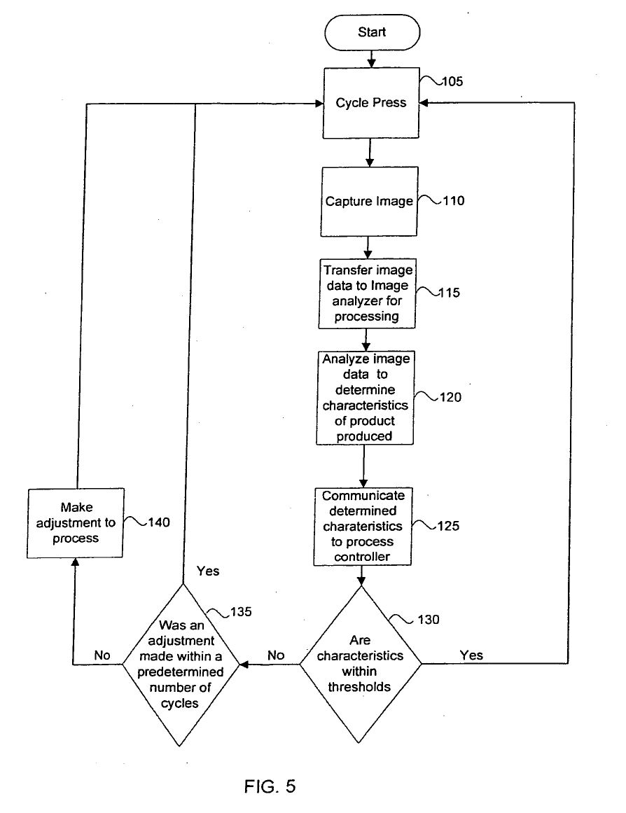

FIG. 5 illustrates a method in accordance with an embodiment of the present invention for controlling parameters of an expanded metal process using feedback from a machine vision system. For ease of understanding, the method will be described with reference to a machine vision system having a single camera. However, as will be appreciated by those of skill in the art, any number of cameras may be used in connection with the present invention.

Prior to activating the control process, a plurality of press strokes are run to produce sufficient expanded metal mesh to extend from the press 20, through the machine vision system 40 to the tensioning device 70. The process control method begins at Step 100 where the press cycles to create an additional row of apertures characteristic of expanded metal.

At Step 105, an image of at least a portion of the expanded metal mesh is captured. In one embodiment, a camera 60a positioned above the expanded metal mesh is triggered by a signal from the process controller 35 indicating the feeder mechanism 15 has indexed a predetermined length of sheet metal. Alternatively, the camera 60a may be triggered by a sensor on the machine vision alignment fixture 41 indicating a new portion of the expanded metal has been indexed.

After capturing an image, image data is transferred from the camera 60a to the image analyzer 65 at Step 110 by the camera interface 62. This transfer step may include processing of the data to facilitate analysis by the image analyzer such as digitizing the image received from the camera 60a.

At Step 115, the received image data is analyzed. As will be understood by those of skill in the art, several known algorithms may be used to process data. For example, edge detection algorithms may be used to identify the edges of the apertures within the expanded metal mesh in the image. Additionally, pixel counters or gauging algorithms may be used to measure the various dimensions of the expanded metal using the image data. It should be understood that any image processing techniques known or developed may be used to evaluate portions of expanded metal in connection with the present invention.

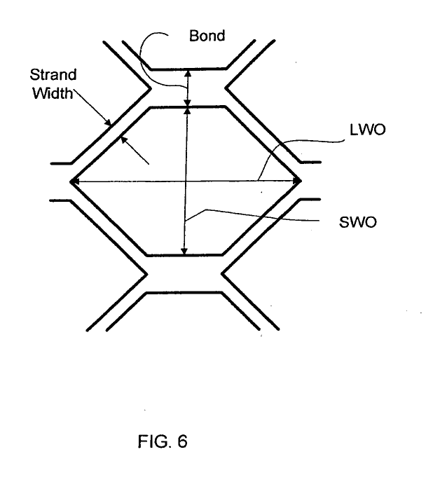

In one embodiment, the image analyzer monitors the aperture size and bond dimension for the imaged portion of expanded metal using the image data received as illustrated in FIG. 6. An expanded metal aperture is typically defined by a short way opening dimension (“swo”) and a long way opening dimension (“lwo”). The short way opening dimension is related to the position of the lower knife 27 relative to the upper knife 23 when the upper knife assembly 21 is proximate the lower knife assembly 25. The long way opening is related to the shape of the upper knife 23.

The bond dimension represents the distance between the apertures in an axis substantially parallel with the swo dimension. This dimension is related to the predetermined length of sheet metal fed into the press 20 with each cycle. As will be appreciated by those of skill in the art, any dimension may be monitored in connection with the present invention.

Returning to FIG. 5, the measurement results for the swo, lwo and bond dimensions as determined by the image analyzer from the image data received are sent to the process controller 35 at Step 120. The process controller 35 then determines whether the dimensions are within predetermined limits at Step 130. Alternatively, the image analyzer may compare the dimensions to predetermined limits and send data to the process controller indicating which dimensions do not satisfy the predetermined limits. Dimensions may run outside of predetermined thresholds for a variety of reasons such as wearing of the knife cutting edges and changes in steel properties.

Before making any adjustments to the process, the process controller 35 determines whether an adjustment was recently made at Step 135. In one embodiment, the process controller 35 tracks the number of press strokes or the number of times the feeding mechanism 15 has indexed material since the last adjustment. If this number is less than a predetermined threshold, an adjustment is not made and the method returns to Step 105. In one embodiment, the predetermined threshold is based at least in part on the number of press strokes or number of feeding mechanism indexes necessary to transfer a specific portion of the expanded metal from the press 20 to the machine vision system 40. In other words, the predetermined threshold is based at least in part on the number of processing cycles necessary for the results of an adjustment made at the press 20 to reach the vision system camera 60a for image capture.

In an alternative embodiment, the process controller 35 delays making a second adjustment until a predetermined time delay has expired, which generally corresponds with the time lag between when a first adjustment is made at the press 20 and when expanded metal mesh representing the change will arrive at the machine vision system 40.

In a further embodiment, the process controller may be programmed to provide a visual or audible alert if a predetermined number of adjustments are made within a predetermined number of process cycles or predetermined time. In addition, the manufacturing process may be stopped. This type of problem may occur when a component of the press works loose or properties of the sheet metal drastically change such as thickness or hardness.

Assuming an adjustment was not made within a predetermined number of cycles and a dimension has been determined not to satisfy a predetermined limit, the process controller 35 makes an appropriate adjustment to the process at Step 140. For example, if the swo dimension is outside of a predetermined range as determined from an image taken by the machine vision camera 60a, a signal is sent to actuator 28a to adjust the location of the lower knife assembly 25. To reduce the swo dimension, the signal instructs the actuator 28a to lower the lower knife an incremental amount. The reverse instruction is given if the dimension is less than the predetermined range. In one embodiment, the incremental amount is predetermined. Alternatively, an adjustment amount may be determined at least in part on the amount the swo differs from the predetermined range.

In the event the bond dimension is outside of a predetermined range, the process controller 35 may alter the signal sent to the feeder indicating the rotation angle for the servo motor thereby adjusting the length of sheet metal indexed into the press. For example, if the bond dimension is short, the rotation angle provide by the process controller to the feeding mechanism is increased by an incremental amount.

In a further embodiment, relationships between the monitored dimensions may be evaluated and appropriate adjustments made to the process. For example, the number of apertures per standard length may be evaluated. To obtain this dimension, the standard unit length, such as an inch or centimeter, is divided by the sum of the swo dimension and the bond dimension. Alternatively, the swo plus bond dimension may be measured directly and used in the calculation. If the apertures-per-unit-length is outside a predetermined threshold, an adjustment may be made to the length of sheet metal feed into the press 20 or the location of the lower knife assembly location or both. The decision of which process parameter to adjust may be based in part on the individual feature measurements relative to their associated allowable ranges.

In an alternative embodiment, the processing method includes capturing more than one image of the expanded metal mesh. In this embodiment, Steps 110-120 are performed for each camera using parallel or serial processing. At Steps 130-135, the process controller 35 will determine for each camera whether an adjustment is necessary.

In addition, the process controller may evaluate the differences between the measurement data associated with each camera and make an adjustment if the differences between the measurements exceed a predetermined threshold. For example, in one embodiment, two cameras 60a, 60b are employed and the difference between the swo measurements is compared. If the difference between the two measurements exceeds a predetermined threshold, a predetermined incremental adjustment may be made to one or both of the actuators 28a, 28b to reduce the difference between the two dimensions. The decision of which process parameter to adjust may be based in part on the individual feature measurements relative to their associated allowable ranges. For example, if the dimension associated with camera 60a is near the lower end of the range and the dimension associated with camera 60b is near the middle of the range, the actuator 28a would be adjusted rather than 28b.

In addition to monitoring whether select dimensions are within predetermined thresholds, dimensional trends may also be monitored. In this embodiment, the process controller 35 stores data received from the image analyzer 65 and determines whether the monitored dimensions are trending toward a predetermined threshold. In one embodiment, the process controller 35 makes a process adjustment in anticipation of a particular dimension exceeding a predetermined threshold based on the trend. Alternatively, a particular type of trend may be associated with specific processing problems such as worn tooling or other maintenance issues. In this case, the process controller 35 may be programmed to recognize this type of trend and to alert an operator visually or audibly of the associated problem.

In a further embodiment, various reporting functions may be provided. To facilitate reporting, dimensional data collected by the machine vision system may be time-stamped and stored in memory. The reporting functions may also include statistical analysis of the data collected such as determining averages, standard deviations and trends for the features monitored. Other calculations may also be performed such as determining the apertures per unit length. Furthermore, adjustments made to the process may be time-stamped and stored by the process controller for subsequent reporting.

When reporting, the system may also allow a user to select a specific portion of the data collected. For example, a user may be provided the option of receiving data and analysis for an entire run, for a desired time period or a desired number of press cycles. As will be appreciated by one of skill in the art, the data and analysis may be sent to a printer so a report can be generated or communicated to other computer systems via wired or wireless connections for review.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A process control system for a sheet metal forming process having one or more adjustable processing parameters, said system comprising:
a press having an upper knife and a lower knife, said press configured to receive a predetermined length of sheet metal between said upper knife and said lower knife and to create a product by sequentially moving said upper knife from a first position spaced apart from said lower knife to a second position proximate said lower knife wherein said upper and lower knives are in contact with said predetermined length of sheet metal, said sequential movement creating a product;
a machine vision system configured to capture at least one image of said product, and to generate dimensional data by determining a dimension of at least one feature of said product by analyzing said image; and
a process controller configured to receive said dimensional data from said machine vision system, said process controller further configured to alter one or more of said processing parameters in response to said dimensional data failing to satisfy a predetermined threshold.

2. The process control system of claim 1 further comprising one or more actuators operatively connected to said lower knife and configured to adjust the location of said lower knife in an axis substantially perpendicular to a longitudinal axis of said lower knife and wherein said one or more processing parameters comprises the location of said lower knife.

3. The process control system of claim 1, wherein said machine vision system comprises:
an alignment fixture configured to receive said product and facilitate capture of said image;
a camera attached to said alignment fixture and positioned to capture said image; and
a camera interface configured to facilitate transfer of said image from said camera to an image analyzer, wherein said image analyzer is configured to generate dimensional data by measuring one or more features of said product using said image received from said camera interface.

4. The process of claim 3, wherein said alignment fixture comprises:
a base having a first surface;
two substantially parallel columns attached relative to said base, wherein said parallel columns are spaced apart to receive said product therebetween and oriented substantially perpendicular to said first surface; and
a camera support adjustably attached to said parallel columns and spaced apart from said first surface such that said product can be received intermediate said first surface and said camera support and wherein said first camera is attached to said camera support.

5. The process of claim 4, wherein said machine vision system further comprises an illumination tube having an illumination source, said illumination tube attached adjacent said parallel columns and said first surface and wherein said alignment fixture is configured to receive said product intermediate said illumination tube and said camera support.

6. The process control system of claim 5, wherein said illumination tube is constructed of non-transparent material and includes at least one aperture in substantial alignment with camera.

7. The process control system of claim 5, wherein said alignment fixture further comprises:
a cross member adjustably attached relative to said parallel columns at a location intermediate said camera support and said illumination tube such that the product can pass between said illumination tube and said cross member; and
a plurality of support fingers attached relative to said cross member wherein said fingers urge said product against said illumination tube.

8. The process control system of claim 1 further comprising a sheet metal feeding mechanism configured to index said predetermined length of sheet metal into said press under control of said process controller and wherein said one or more processing parameters comprises said predetermined length of sheet metal.

9. The process control system of claim 3, wherein said machine vision system further comprises a second camera configured to capture a second image of said product and to measure at least one feature of said product by analyzing said second image, and wherein said dimensional data includes measurements from said first image and said second image.

10. The process control system of claim 9, wherein said first image and said second image are of separate portions of said product.

11. The process control system of claim 9, wherein said process controller is configured to compare measurements based on said first image with measurements taken from said second image and further configured to alter a process parameter based at least in part on said comparison.

12. The process control system of claim 1, wherein said process controller includes a memory configured to store said dimensional data for subsequent reporting.

13. A method of controlling a sheet metal forming operation comprising the steps of:
indexing a predetermined length of sheet metal between a first knife and a second knife;
sequentially moving said upper knife from a first position spaced apart from said lower knife to second position proximate said lower knife wherein said upper knife and said lower knife are in contact with opposing surfaces of said indexed sheet metal at said second position thereby creating product;
capturing at least one image of said product;
processing said at least one image to determine a dimension of one feature of said product to create dimensional data;
comparing said dimensional data to a given threshold; and
adjusting a processing parameter in response to said first measurement data exceeding said threshold.

14. The method of claim 13, further comprising:
capturing a second image of said product,
processing said second image to measure said one feature of said product to create second dimensional data;
comparing said second dimensional data to said given threshold; and
adjusting a processing parameter in response to said second dimensional data exceeding said threshold.

15. The method of claim 14 further comprising the steps of:
comparing said dimensional data determined from said image to said second dimensional data; and
adjusting a process parameter based at least in part on said comparison.

16. The method of claim 13, wherein said step of adjusting a processing parameter comprises adjusting said predetermined length of sheet metal.

17. The method of claim 13, wherein said step of adjusting a processing parameter comprises adjusting the position of said lower knife in a direction substantially perpendicular to a longitudinal axis of said sheet metal.

18. The method of claim 13, further comprising the steps of:
storing said dimensional data in a memory; and
performing statistical analysis on said dimensional data stored in said memory.
